(19) United States
(12) Patent Application Publication
(10) Pub. No.: US 2012/0018526 A1
(43) Pub. Date: Jan. 26, 2012

(54) METHOD OF CREATING SALT AEROSOL FOR BREATHING BY NEBULIZING AN AQUEOUS SALINE SOLUTION

(76) Inventors: Livia Tiba, Ontario (CA); Constantin Tiba, Ontario (CA)

(21) Appl. No.: 13/201,628

(22) PCT Filed: Mar. 12, 2010
(86) PCT No.: PCT/EP10/53223

§ 371 Date: Aug. 16, 2011

Related U.S. Application Data
(60) Provisional application No. 61/161,812, filed on Mar. 20, 2009.

(51) Int. Cl. B05B 17/06

(52) U.S. Cl. 239/4

(57) ABSTRACT

The present invention concerns a method for nebulizing an aqueous saline solution comprising sodium chloride, the method comprising the steps of: placing a quantity of the aqueous saline solution having a salt concentration ranging between 0.5 mg/mL and the NaCl solubility in water at 25° C. into a chamber of an ultrasonic nebulizer, the ultrasonic nebulizer having at least one ultrasonic cell used for nebulizing the saline solution; operating the ultrasonic nebulizer to generate droplets of the aqueous saline solution between 0.1 microns and 5 microns in size and in a quantity between 1 ml and 200 ml per hour; and forcing the nebulized saline solution droplets to leave the chamber through at least one opening of the ultrasonic nebulizer such as to place the nebulized saline solution droplets into the indoor air. The invention further concerns a method of treatment of respiratory ailments.

### FIELD OF THE INVENTION

The present invention relates to a method of creating and delivering sodium chloride (NaCl) aerosol to a person's respiratory system to provide treatment for respiratory ailments, allergies and to provide general respiratory hygiene.

### BACKGROUND OF THE INVENTION

The benefits of speleotherapy are well known and well documented in Europe. Speleotherapy (from Greek speleos=cave) or underground therapy uses the micro climate of natural salt mines to treat respiratory diseases, a treatment that has been practiced in old salt mines of Eastern Europe since the early 19th century.

In the mid 18th Century a Polish health official Felix Botchkowski, noticed that the workers of salt mines did not get ill with lung diseases. He wrote a book about the effects of salt dust in 1843. His successor M. Poljakowski founded a Salt Spa in Wieliczka near Krakow, which is still in operation. During the Second World War salt mines were often used as bombproof shelters. After spending time there many people who suffered from asthma felt that their health had gotten better! Today there are many salt sanatoriums in Europe (Austria, Hungary, Poland, Romania, Russia and other countries).

Speleotherapy has been recognized as a highly effective drug-free treatment method proved by many clinical studies. However, the cost of travel and accommodation and the limited number of patients admitted at a time in salt sanatoriums, made this method inconvenient.

In the 1980s, the Russians began to build halochambers (salt rooms) to replicate the microclimate of salt mines. This therapy is known as Halotherapy. These halochambers have floors and walls lined with rock salt (halite) and spread very fine grinded salt particles using an air stream. Patients sit in the halochamber for an hour per session while comforted with music and relaxed environment. Another approach has been the desktop halotherapy device, which has tubes for breathing in the dry salt aerosol.

A ceramic salt pipe from Hungary represents a third approach. The patient breathes in gently through the mouth, and then exhales through the nose. Another approach was a Romanian device that uses forced air that passes a micro crystallized salt filter and spreads dry micro particles into the indoor air.

A fourth, popular device is the rock crystal lamp (Pakistan) or salt lamp (Poland), which is comprised of a largish piece of rock salt with an attached light bulb that glows through the salt and whose heat causes micro particles to become airborne.

Generally speaking, the prior art only disclosed aerosols of dry powder salt of under 5 microns in size. In addition, in prior halotherapy or speleotherapy treatment, patients had to reside in the salt cave for up to 4 hours per day for treatment duration of 6 to 12 days. In places where salt caves were not available, artificial salt rooms have been created and the same environmental conditions of salt caves were reproduced for duration of 40 min. up to 1 hour per day for treatment duration of 6 to 12 days.

Recent studies have found that aerosols of dry powder salt can provide relief to common cold, sore throat, cough, headache, etc. The prior art system used here is known as bench top laboratory system, where a person lies in a chamber and exposes his/her face through an opening. The aerosol sodium chloride powder is then sprayed on the face for inhalation.

Although the above procedures exist in the prior-art, they are not very practical and advantageous. An example of such inconvenience is, as explained above, sitting in a salt cave for 4 hr/day or in an artificial halo chamber for 40 min/day to 1 hr/day in treatments lasting 6 to 12 days. The size of sodium chloride particle is a very important factor in halotherapy. However, by using powder or saline sprays, or even lamp techniques, the size of the particles cannot be controlled, resulting in ineffective treatment or longer times to heal.

It is, therefore, an object of the present invention to provide a method which can deliver quantities of aerosol sodium chloride particles of a therapeutically useful size by means of a controlled ultrasound technology and a method of treatment that can be used during the night while the user is sleeping.

Another object of present invention is to provide a saline (NaCl) solution treatment method in which the size and quantity of the aerosol particles in the treatment zone can be controlled by means of setting the operating parameters of an ultrasonic nebulizer in order to treat common cold, sore throat, cough, headache, and the like.

Yet another object of the present invention is to provide the above mentioned method of treatment, which can be implemented anywhere, using an ultrasonic nebulizer which is easy to operate, small and is travel friendly and in which the aerosol particles are freely breathable.

A further object of present invention is to provide a treatment method that can be given during the night and while the user is sleeping and in which the humidity in the treatment zone is practically not affected

Within the framework of the above object a further object of the present invention is to provide a method of treatment which does not affect the usual activity of the user. It can also be used with room fresheners, mint flavors etc., along the saline solution during the treatment.

### SUMMARY OF THE INVENTION

The above objects as well as further objects that will become apparent hereinafter are achieved by the present invention as defined in the appended claims.

The approach according to the present invention is different than all of these methods by the fact that the present invention uses a saline solution and the existing ultrasonic technology to create sodium chloride (NaCl) aerosol for easy breathing, conveniently providing its use at home, during the night, while sleeping. The main curative factor in this treatment is the presence in the atmosphere of the room, for instance an average room in a home (about 40 m³), of sodium chloride (NaCl) micro particles for long term breathing.

In one aspect of the present invention, a method of providing halotherapy comprises of an ultrasonic nebulizer, which contains saline solution. The user operates the ultrasonic nebulizer to release the breathable size aerosol particles of 0.1 to 5 microns, preferably 0.1 to 2 microns, of sodium chloride solution.

### BRIEF DESCRIPTION OF THE INVENTION

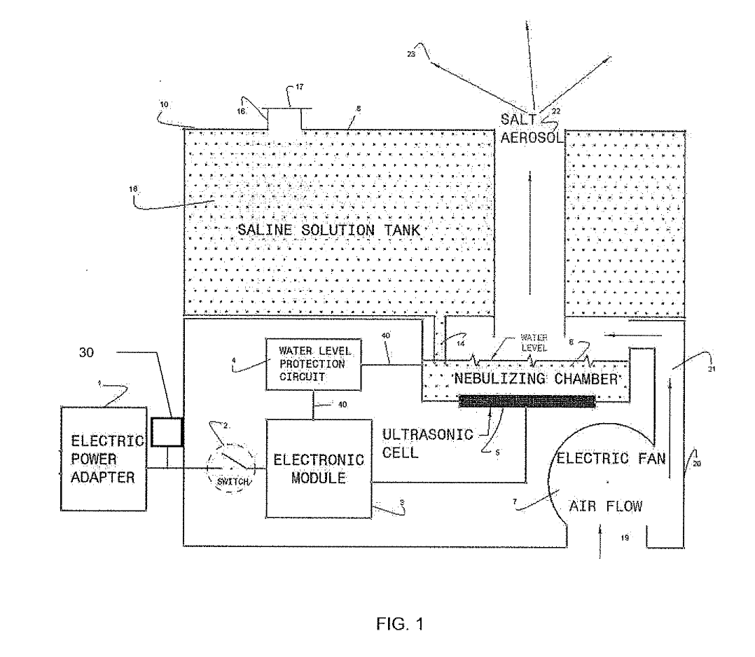

FIG. 1—Represents the schematic view of delivering sodium chloride solution aerosols from the ultrasonic nebulizer.

### DETAILED DESCRIPTION OF THE INVENTION

A very important factor in the effectiveness of sodium chloride (NaCl) aerosol particles treatment is the size and quantity in the treatment zone (average sized room which is assumed to be about 40 m³) of the sodium chloride aerosol particles. The size of the aerosol particles can be controlled, as well known in the art, by varying the frequency of the ultrasonic nebulizer. Further, the quantity of the aerosol particles can be controlled by setting the flow rate of the nebulizer which is also known to the person skilled in the art, and in this manner one can achieve a desired concentration of aerosol particles in the treatment zone based in the assumed average room size.

If the particles sizes are large they will mainly stick to the upper part of the lung and they cannot penetrate into the lung. If the particles are sufficiently small they will travel with the air deep into the lung reaching the alveoli. However, control of the quantity (concentration) and size of the sodium chloride aerosol particles using the prior art methods is very difficult. For example, when using a dry micro crystallized salt filter, at the beginning there will be more particles airborne and their quantity will diminish abruptly in time. In salt rooms the quantity of salt in the air is high because only a short exposure time is possible.

Using a saline solution as the source of the airborne salt micro particles, as provided for by the present invention, and by controlling the concentration of the saline solution as well as the nebulized quantity, very fine adjustments of the quantity of the aerosol particles are possible and recommended progressive exposure is easy to accomplish. The humidity gradient generated by the ultrasonic nebulizer device is not significant; typically 1-30, more preferred 4-20, most preferred 7-10 ml of water is evaporated during 1 hour. As compared to this, a standard humidifier generates 100-1000 ml/hour. A continuous exposure of 8-10 hours/day with a small concentration is desirable and easy to accomplish using the device during night time. Due to the relatively low humidity gradient generated by the ultrasonic nebulizer device the water evaporates from the aerosol particles and just the salt remains by the time the aerosol is breathed.

Apart from the production of sodium chloride aerosols, a second step is needed to ensure that the sodium chloride molecules are able to reach the alveoli, the smallest part of the lungs, and clean the whole respiratory system. The lungs of an adult human present a large surface area where a considerable amount of secretions are produced forming blockages and impeding easy breathing. After being breathed in through the nose or mouth, the air together with aerosol particles obtained from the sodium chloride solution is carried and passed into the trachea and then through smaller and smaller bronchi and bronchioles into the alveoli, hygienising the whole respiratory system, humidifying and fluidizing the secretions of the respiratory system, enhancing the movement of cilia in the bronchi and helping the rapid elimination of the residual tar and foreign allergens. In the range 0.1-2.5 microns—having the same size as the most damaging micro particles from auto and industrial pollution, and invisible to the human eye—the aerosol micro particles of sodium chloride solution penetrate into every corner of the bronchi, bronchioles, and alveoli and deposit upon the surface, expelled later with the fluidized secretions. With the ultrasonic nebulizer, the sodium chloride solution aerosol micro particles placed into the indoor air for easy breathing, having a breathable average size of preferably less than 5 microns, and most preferably less than 2 microns. It should be noted that at a distance from the device the water evaporates and just the salt remains by the time the aerosol is breathed.

The nebulizer described therein can advantageously be used to produce the inhalable aerosols. Thanks to its convenient size and simplicity, this device can be carried around in the house or when traveling, and it is easy to operate by younger or elder people. Using a wall transformer, the voltages used by the electronic circuit inside are not dangerous in the case of an accidental spill of the saline solution.

Essentially, the conveniently existing ultrasonic nebulizer used for this purpose consists of a plastic housing containing the electronic circuit generating the electric power for the ultrasonic cell and having the required parameters (voltage, intensity and frequency), the switch, the ultrasonic cell, low water level protection circuits and a fan generating the air flow and assuring the cooling of the electronic device. On the upper part of this housing there is the nebulizing room, where under the action of the ultrasonic cell vibration, the saline solution is nebulized in micro particles. The detachable water tank is closing this area, so the nebulized particles are moved by the air stream generated by the fan and forced into the room air. The protection circuit shuts off the electronic device if the water level is low in the nebulizing room. The reservoir is containing the saline solution and is supplying the saline solution into the nebulizing compartment through a cylindrical opening.

In order to operate the device, the saline solution needs to be prepared. The removable tank has a screwed cap equipped with a valve. Taking off the cap, the tank shall be filled with water. The recommended quantity of sodium chloride is added to the water using a measuring device. Once the cap is screwed back in, the saline solution in the tank is not leaking due to the valve. This valve is opening once the tank is placed in the right location and the saline solution is released into the nebulizing room. The power adaptor has to be plugged into an electrical outlet and the on/off button pushed to turn the device on. If the water level in the nebulizing room is sufficient, the protection circuit will allow the electronic circuit to power the ultrasonic cell, the saline solution is nebulized and the air stream generated by the electric fan pushes the generated sodium chloride solution aerosol micro particles in the surrounding air.

Clinical studies concluded that optimal sodium chloride solution aerosol concentration in the air for halotherapy is between 0.5 and 9 mg/m³ depending on the disease (see http://www.halotherapy.com/results.htm; http://www.salinetherapy.com/html/research_studies.html). For comparison, the ocean aerosol contain from 0.1-10 mg/m³, depending on weather, climate, ocean condition, etc. (http://www.gepower.com/prod_serv/products/gasturbine_inletsystem/en/downloads/book_of_salt.pdf)

Most of the particles used in clinical tests were below 5 microns, preferably below 2 microns. Considering these results as required, the first step was to choose or setup an ultrasonic cell generating particles under 5 microns, preferably under 2 microns.

### Example 1

Starting with an output quantity of 10 ml of saline solution nebulized in one hour time interval. After experiments it was found that a desirable aerosol mass concentration of sodium chloride of 1 mg/m³ in an average room [average room volume is considered to be 40 m³] will serve the purpose and it is safe for starting a treatment. Subsequently, the saline solution concentration may be calculated.

The desired sodium chloride mass concentration to be placed in each cubic meter of air per hour is:

D=1 mg/(m³×hr)

The volume of the sodium chloride solution nebulized in one hour is:

Vh[ml]=10 ml/hr

The volume of the tank containing the sodium chloride solution is:

V_{T}[ml]=500 ml

The time necessary to nebulize a full tank: T [hours]

In our case:

T[hrs]=V_{T}/Vh=500 ml/10 ml/hr=50 hours

The air volume V_{R} EMI of an average room is considered to be 40 m³.

V_{R}[m³]=40 m³

The quantity of sodium chloride to be added to a full tank to be used T hours is St [milligrams]

St=T×D×V_{R}

In the case of Example 1:

St=50 hrs×1 mg/(m³×hr)×40 m³=2000 mg=>2 grams of salt/500 ml tank for 50 hrs.

This is the recommended quantity to be used as a start for therapy and in time the quantity can be increased gradually.

In order for the user to be able to get the right dosage using a volumetric method as for example using a kitchen measuring teaspoon, knowing salt density is 2.16 (http://en.wikipedia.org/wiki/Sodium_chloride) we found that the 2 grams of salt take a volume of approx 1 ml (¼ tsp). This is the quantity we recommend users to add in the full tank of water.

In time, even if the device is permanently placing salt particles in the air, their concentration is not growing arithmetically due to sedimentation, air movement in the house and breathing.

Using the data of Example 1, one may calculate the concentration of the sodium chloride solution used by the ultrasonic nebulizer:
St the quantity of sodium chloride to be added to a full tank is 2 g/500 ml which after scaling reads 4 mg/ml.

The components of the nebulizer are made of a material suitable for the purpose. The housing of the ultrasonic cell and, as far as its operation permits, other parts are preferably made of plastics, e.g., by injection molding.

The ultrasonic nebulizer described above is suitable for nebulizing the saline solution in accordance with the invention to produce sodium chloride aerosol in the indoor air suitable for breathing and safe for the environment being comparable with the natural ocean aerosol or the one used in speleotherapy.

Referring now to the drawings and more particularly FIG. 1, a preferred method of delivering halotherapy by using the present invention is illustrated. The ultrasonic nebulizer 10 used for the halotherapy treatment consists of a plastic housing 20, which includes an electronic circuit 30 which carries the power for ultrasonic cell 5, controlled by a switch 2 which is connected to the electronic power adapter 1; the switch 2 controls the electronic module 3, which supplies power to the ultrasonic cell 5. Water lever circuit 4 is connected to electronic module 3 by a connection 40 which also connects the nebulizing chamber 6 to the water level protection circuit 4. Saline solution 18 from the tank 8 flows to the nebulizing chamber 6 through the passage 14, where salt particles are produced; these particles are dispersed by an electric fan 7 through the path 21 to the exit 22 as salt aerosol 23. Airflow to the fan is provided by a rear opening at 19.

In a preferred embodiment of the present method, sodium chloride particle sizes range from 0.1 to 5 microns, most preferred range from 0.1 to 2 microns, and predetermined dose is 2 grams for 500 ml of water present in the chamber. Such dosage and sizing provides fine aerosol sodium chloride particles to relieve ailments in the respiratory tracts. Dosage may be varied for individual users.

To operate the device 10, the first step is to prepare the saline solution 18; water is poured into the tank 8 though the opening 17 and respective amount of sodium chloride is added to the tank 8, opening is closed by a screw cap 16. The electric power adapter is plugged to a power chord, switch 2 is tuned on. If the water level in the nebulizing room is sufficient, the protection circuit 4 will allow the electronic module 3 to power the ultrasonic cell 5, the saline solution is nebulized and the stream generated by the electric fan pushes the generated salt micro particles to the air through the opening 22.

In general, a method of nebulizing an aqueous saline solution comprising Sodium Chloride (NaCl) with a concentration ranging from 0.5 mg/mL up to the NaCl solubility in the water at 25° C. (see value in Wikipedia 359 mg/mL at 25° C. http://en.wikipedia.org/wiki/Sodium_chloride) for halotherapy is disclosed. The nebulizing process is generating droplets less than 5 microns, preferably less than 2 microns, in size with the purpose of inhaling these particles, the process comprising: (a) placing a quantity of the saline solution in a chamber having at least one ultrasonic cell used for nebulizing the saline solution; and (b) forcing the nebulized saline solution droplets to leave through at least one opening with the purpose of putting these inhalable droplets into the indoor air.

This method can utilize an ultrasonic nebulizer for nebulizing particles with diameter range of 0.1 to 5 microns, preferably 0.1 to 2 microns. The aerosol particles produced by a nebulizer can either flow based on slow diffusion processes or may be forced to leave the nebulizing area using a forced air stream. The concentration of the sodium chloride solution may vary, preferably, the concentration of sodium chloride in the aqueous solution is between 0.5 mg/ml and up to NaCl solubility in the water at 25° C. The quantity of the aqueous saline solution placed in the indoor air can also vary to any desired values, preferably between 1 ml and 200 ml per hour.

The process for administering sodium chloride (NaCl) particles by inhalation to a patient comprises of nebulizing an aqueous solution at a rate between 1 ml and 200 ml per hour comprising between 0.5 mg/mL and up to NaCl solubility in the water at 25° C. to form inhalable droplets of the aqueous saline solution, and wherein the inhalable droplets are then freely inhaled by the patient. The aqueous composition comprises at least 0.5 mg/mL of sodium chloride and the average particle size of the inhalable droplets is less than 5 microns, preferably less than 2 microns. The process is performed using an ultrasonic cell and additional electronic circuits as nebulizing agent and the nebulized particles are dispersed in the patient's room with the purpose of being inhaled trough natural breathing.

Aqueous solutions of sodium chloride can be used with other solutions or additives, such as solutions of potassium chloride, ascorbic acid, menthol, mint flavors, citrus flavors, sodium bicarbonate, breath fresheners and their combination. However, it should be understood that the other solutions are added to the initial aqueous solution of sodium chloride and that concentrations of sodium chloride indicated in the invention are referred to the initial aqueous solution of sodium chloride.

1-12. (canceled)

13. A method for nebulizing an aqueous saline solution comprising sodium chloride, the method comprising the steps of:
placing a quantity of the aqueous saline solution having a salt concentration ranging between 0.5 mg/mL and the NaCl solubility in water at 25° C. into a chamber of an ultrasonic nebulizer, the ultrasonic nebulizer having at least one ultrasonic cell used for nebulizing the saline solution;
operating the ultrasonic nebulizer to generate droplets of the aqueous saline solution between 0.1 microns and 5 microns in size and in a quantity between 1 ml and 200 ml per hour; and
forcing the nebulized saline solution droplets to leave the chamber through at least one opening of the ultrasonic nebulizer such as to place the nebulized saline solution droplets into the indoor air.

14. The method of claim 13 wherein the size of the droplets of the aqueous saline solution is between 0.1 micron and 2 microns.

15. The method of claim 13 wherein the ultrasonic nebulizer is operated to generate between 1 ml and 30 ml of water per hour, preferably between 7 ml and 10 ml of water per hour.

16. The method of claim 13 wherein the ultrasonic nebulizer is operated to generate the droplets of the aqueous saline solution for a time span between 8 to 10 hours per day.

17. The method of claim 13 wherein quantity of the aqueous saline solution placed in the chamber of the ultrasonic nebulizer has a salt concentration ranging between 0.5 mg/mL and 10 mg/mL.

18. A method for treatment of respiratory ailments comprising the steps of:
generating droplets of an aqueous saline solution between 0.1 microns and 5 microns in size and in a quantity between 1 ml and 200 ml per hour by means of an ultrasonic nebulizer having at least one ultrasonic cell, the ultrasonic nebulizer having a quantity of the aqueous saline solution having a salt concentration ranging between 0.5 mg/mL and the NaCl solubility in water at 25 C.°,
forcing the nebulized saline solution droplets to leave the ultrasonic nebulizer through an opening thereof such as to place the nebulized saline solution droplets into the indoor air.

19. The method of claim 18 wherein the size of the droplets of the aqueous saline solution is between 0.1 micron and 2 microns.

20. The method of claim 18 wherein the ultrasonic nebulizer generates between 1 ml and 30 ml of water per hour, preferably between 7 ml and 10 ml of water per hour.

21. The method of claim 18 wherein the ultrasonic nebulizer is operated to generate the droplets of the aqueous saline solution for a time span between 8 to 10 hours per day.

22. The method of claim 18 wherein the ultrasonic nebulizer is operated in a room having a volume of about 40 m³.

23. The method of claim 18 wherein the nebulized aqueous saline has a salt concentration ranging between 0.5 mg/mL and 10 mg/mL.

24. The method of claim 13 wherein the aqueous saline solution further includes an additive selected from the group comprising potassium chloride, ascorbic acid, menthol, mint flavors, citrus flavors, sodium bicarbonate and breath fresheners and combinations thereof.

25. The method of claim 18 wherein the aqueous saline solution further includes an additive selected from the group comprising potassium chloride, ascorbic acid, menthol, mint flavors, citrus flavors, sodium bicarbonate and breath fresheners and combinations thereof.
